(19) United States
(12) Patent Application Publication
(10) Pub. No.: US 2005/0041101 A1
(43) Pub. Date: Feb. 24, 2005

(54) Method and device for identifying motion in an image

(76) Inventor: Markus Weber, Worth (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/486,826

(22) PCT Filed: Aug. 24, 2002
(86) PCT No.: PCT/DE02/03113

(30) Foreign Application Priority Data
Aug. 24, 2001 (DE) 10140695.9

(51) Int. Cl. G06K 9/00

(52) U.S. Cl. 348/135; 382/107

(57) ABSTRACT

The invention relates to a method for identifying moving areas of an image that contains pixels, said image having been produced by an interlacing method. A first half-image corresponds to the even lines of an image and the second half-image corresponds to the uneven lines of the image. According to the inventive method, which can be used for a multitude of different video materials, a motion can be easily identified in an image, when at least three subsequent pixels of the same column, one of the pixels being derived from the half-image and the other two being derived from the other half-image, are evaluated with respect to a pixel parameter. Depending on the result of said evaluation, a motion in a section of the image that comprises at least one of the three pixels can be indentified.

The present invention relates to a method for identifying moving areas of an image having pixels, which image has been generated according to the line interlacing method (e.g. television picture), the image having two fields or half-images, a first field or half-image having the even-numbered lines of the image and the second field or half-image having the odd-numbered lines of the image. In this case, a line interlacing method is understood to mean, in particular, that there is a temporal difference (with regard to recording or generation) between the two fields, which difference preferably corresponds to twice the frame frequency.

In contrast to conventional film, video material is usually recorded using the line interlacing method. In this case, firstly only image lines having an odd line index are scanned, and then the image lines having an even line index are scanned with a temporal delay (half the frame distance=twice the frame frequency). The line sequence in the line interlacing method in accordance with the PAL system is therefore 1,3,5 . . . 2,4,6. The advantage of the line interlacing method or interlace scanning method originating from television technology consists, in particular, in avoiding flicker. A pixel (from “picture element”) is the smallest division of a video frame or of a scanning line of a display device, such as e.g. a computer monitor or the like.

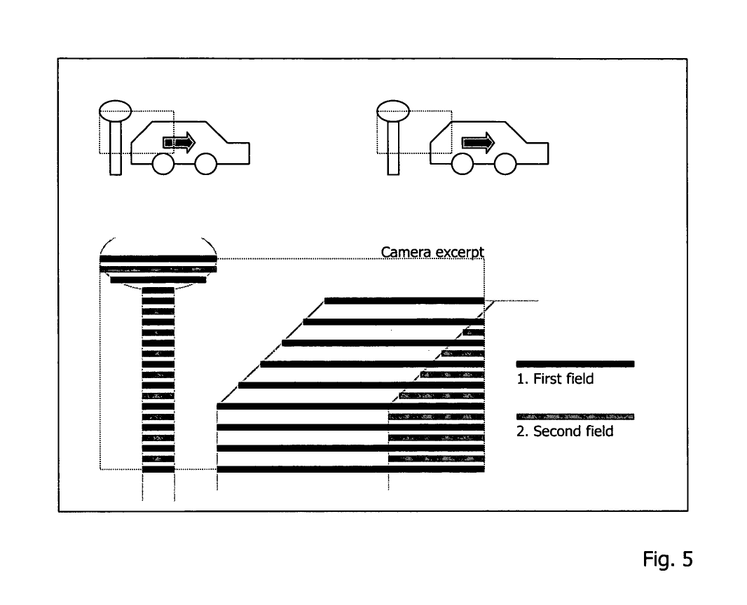

If the recorded situation is static, the temporal delay inherent in the line interlacing method does not become apparent and the image obtained is identical to a progressively scanned image (line sequence: 1, 2, 3 . . . ). If, in contrast to this, the recorded situation contains motion, the two fields differ in the areas in which motion takes place. In this connection, reference is made to FIG. 5, which reveals in particular the arising of the so-called “comb effect” or of “comb artefacts”. The upper half of FIG. 5 diagrammatically represents a situation to be recorded by a camera (not represented), comprising an immobile object, illustrated by a tree, and an object that moves in the direction of the arrow depicted, illustrated by a vehicle. The camera excerpt of the video camera is indicated by a dotted frame. In this case, the situation represented in the top left half of FIG. 5 temporally precedes the situation represented in the top right half of FIG. 5. This is also evident from the greater distance between vehicle and tree in the top right half of FIG. 5. The temporal interval between the two situations is such that the first field registers the situation represented in the top left half of FIG. 5 and the second field registers the situation represented in the top right half of FIG. 5. This is clearly discernible from the camera excerpt represented in the bottom half of FIG. 5. In this case, the pixels of the first field are indicated black and those of the second field gray. It can clearly be gathered from the representation of FIG. 5 that the imaging of the nonmoving object is unproblematic, while the image area in which the motion takes place has a so-called comb effect. In this respect, attention shall be drawn to the rear contour of the vehicle. In principle, it holds true that if the image has moving portions, the two fields differ in the areas in which motion takes place. This comb effect is discernible by the naked eye and acts as an unsettling factor or flicker during the viewing of the image, particularly if a still image or single image is to be generated. It should be noted that, in principle, a relative movement between camera and situation to be recorded is critical for the arising of the comb effect. Even an unmoving scene can therefore be impaired by the comb effect in the event of severe camera movement.

If the image is displayed in the original state, the comb effect is a disturbance, as explained above. In order to remedy this, just one field could be displayed, for example, in order to generate a still image. This is not a satisfactory solution, however. The image reproduction quality suffers in this case since only half of the vertical resolution can be obtained from one field. The motion may, in principle, also be detected by comparing temporally successive frames, but this approach fails e.g. when a periodic motion (e.g. wind turbine) is involved or when a poor contrast difference is present or when no comparison images at all are present.

The invention is therefore based on the object of avoiding the disadvantages of the prior art, and in particular of developing a method of the type mentioned in the introduction which makes it possible, in a simple manner, to detect motion in an image, in particular a video frame or image, which can be used for a multiplicity of different video material.

In the case of a method of the type mentioned in the introduction, this object is achieved by virtue of the fact that for at least three successive pixels of the same column, one of the pixels originating from one field and the other two pixels originating from the other field, an evaluation of the at least three pixels with regard to a pixel parameter is carried out, in which case, depending on the result of the evaluation, motion is identified in an area of the image which has at least one of the three pixels.

One advantage is that the present method makes it possible to detect the comb effect automatically, and in particular selectively for different areas of the image. The detected areas can be edited and the reproduction quality can thus be improved. In particular, this is advantageous for applications for generating a still image or when magnifying an image (excerpt).

A further particular advantage of the present invention is that it can be used not only for video processing but also for other purposes, such as e.g. for security applications. For a video camera used for monitoring, for example, the present method can be used to identify motion in a simple manner. The method can be used particularly well if the camera monitors an unmoving scene and any motion is in principle suitable for triggering an alarm. Moreover, the present invention can be used simultaneously for a multiplicity of such monitoring cameras and trigger an alarm virtually in real time.

In an advantageous manner, the evaluation is a comparison, two jumps in the pixel parameter values of the successive pixels indicating that motion is present in the area, while one or no jump in the pixel parameter values indicates that there is no motion present in the area. This method suffices for a series of situations or initial images. However, this encounters its limit when the two jumps have been caused by the background instead of by a comb effect.

Preferably, the pixel parameter value is one or more parameters of a color space. In this case, any color space is suitable, in principle, as the color space. In this case, a color space is a mathematical representation of a set of colors. Mention shall be made, merely for the purposes of illustrating the present invention, of the RGB space (used in computer graphics and color television technology), the YIQ, Yuv and YC_{b}Cᵣ space (used in broadcasting and in television systems) and the CMYK space (used in color printing). It is possible to alternate between these spaces by means of conversion formulae. For the processing of video frames, the preferred color space is the YCbCr color space. The method is preferably carried out with one pixel parameter value, but it is also possible to carry out the method several times with different pixel parameter values or else to use different pixel parameter values for evaluation for different areas of the image or different images of a film.

A preferred pixel parameter for the evaluation is the luminance (luma) Y, i.e. the brightness information. In principle, it is possible to use any parameter of a color space, e.g. also the chrominance (chroma) C_{b} and/or Cᵣ, i.e. the color information, or a different quantity, in particular derived therefrom.

In an advantageous manner, a Fourier transformation is applied to the pixel parameters of the at least three pixels, from which corresponding Fourier coefficients are obtained. Motion is identified if at least one of the Fourier coefficients fulfills a predetermined criterion. The Fourier transformation succeeds in suppressing the absolute values of the pixel parameters of the selected pixel group, i.e. the DC component, and in obtaining instead information about the spatial frequencies that are characteristic of the comb effect.

In principle, the selection of the number in the group of pixels which are subjected to the evaluation is important. It is necessary to weigh up different criteria in this case. If the group contains many pixels, then the computational complexity increases. The meaningfulness of motion detected in the area of the many pixels is then likewise limited, and in particular makes postprocessing of the image difficult. In practice, it has been found that a group of four pixels (xₘ, m=0,1,2,3) is preferred. This is due to the fact that with three pixels, the comb effect still cannot be detected with sufficient reliability in all cases.

In this case, it is preferred for the Fourier coefficients to be determined by the following formula
Yₙ=Σ_{m=0,3}xₘe^{-iωmn}, where ω=2π/4,
|Y₂|: |Y₁|≧S being used as a criterion for identifying motion, and S being a predetermined or predeterminable threshold value.

In an advantageous manner, the Fourier coefficients are determined directly by the following formulae
Y₀=X⁺₀₂+X⁺₁₃
Y₁=X⁻₀₂+iX⁻₁₃
Y₂=X⁺₀₂−X⁺₁₃
Y₃=X⁻₀₂−iX⁻₁₃
where X⁺₀₂=x₀+x₂, x⁺₁₃=x₁+x₃, X⁻₀₂=x₀−x₂ and X⁻₁₃=x₁−x₃ hold true, where |Y₂|:Y₁|≧S is used as a criterion for identifying motion, and where S is a predetermined or predeterminable threshold value. In this way, the Fourier transformation does not have to be carried out every time, rather merely the result of said Fourier transformation can be calculated directly according to the above formulae.

In this case, the present invention has recognized that the magnitude or parameter
|Y₂|: |Y₁|
represents a measure of the degree of motion. Finding such a magnitude is preferred in particular because different correction measures for the image can be initiated depending on the intensity of the motion. In the simplest case, if no significant motion is identified, extensive processing is not carried out in this area of the image. This quantity may likewise be compared with a preset alarm parameter. In this case, the alarm may be an alarm which appertains to security technology and for example informs guard or security personnel of the occurrence of motion; however, the “alarm” may also just be used to indicate to a video technician that the image quality is impaired by the comb effect.

In order to provide a gradated alarm, it is preferred for a plurality of threshold values to be predetermined, the degree of motion being determined depending on the highest threshold value for which the assessment magnitude or parameter |Y₂|: |Y₁| is greater than or equal to this threshold value.

By means of experiments with a multiplicity of different images recorded by many different recording devices, it was found that if the threshold value S lies in a range of values of S less than or equal to 30, in particular from approximately 5 to, approximately 15, and is preferably about 8, an optimum identification of the motion can be found.

The scanning of the image or of a partial area thereof is preferably effected by a procedure in which at least part of the image is scanned columnwise, in particular from left to right, with in each case a group of at least three pixels of the same column that lie one above the other, in which case, after passing through essentially all the columns, the scanning is repeated in a manner displaced by essentially one line. Therefore, the method according to the invention need not necessarily be applied to the entire image. It may also be applied to image excerpts without any impairment, as long as said image excerpts have at least three lines or a number of lines corresponding to the number of pixels used (four pixels or lines are preferred). By way of example, it is also possible to omit noncritical areas, e.g. edge areas.

In this case, the area of the image in which motion is identified is advantageously an individual pixel, the individual pixel preferably being one of the inner pixels with regard to the group of pixels. In particular for the case where four pixels are used, it is preferred for the individual pixel to be the pixel having the second lowest line number.

In particular in applications appertaining to security technology, but also for the automatic testing of image material, it is preferred for an alarm to be triggered in response to the identification of motion in the image. In this case, the alarm may be, in particular, a visual and/or acoustic alarm.

Preferably, after the identification of motion, the image is postprocessed in such a way that the image is accepted unchanged in areas in which there is no motion present, whereas only pixel information from one field is used for representing areas of the image in which motion has been identified. In this case, it is advantageous that perception by the human eye in the identification of motion in any event has corresponding mechanisms in order to detect the motion particularly well. In particular, this mechanism also acts to the effect that the images that are processed in this way are optically perceived as being of good quality.

More precisely, for a location of the image in which motion has been identified, only the pixel value from one field is used for the representation, in which case, at respective locations of the other field at which motion has likewise been identified and which are adjacent to the location, use is made of substitute values obtained by an interpolation of pixel values of said one field from surroundings of the location.

Preferably, the surroundings of the location used for the interpolation reach approximately as far as the third successive pixel of said one field. Although merely taking account of the directly adjacent pixels is sufficient for some cases, it generally only represents an often inadequate first-order approximation. The first approximation may nevertheless be preferred, to be precise for example in the case in which the motion is present in an edge region of the image and there are no larger surroundings present.

Furthermore, it is preferred for the method according to the invention to be implemented as a software program. However, it is equally possible for the method to be embodied as hardware or to be integrated into a microchip, a camera, a camcorder, a television set, a video recorder, a DVD player or the like.

Further preferred embodiments of the invention are disclosed in the dependent patent claims.

The invention and further features, aims, advantages and application examples thereof are explained in more detail below on the basis of a description with reference to the accompanying drawings. In this case, all described and/or pictorially represented features form the subject-matter of the present invention by themselves or in any desired expedient combination, to be precise independently of their combination in the patent claims or the dependencies thereof. In the drawings:

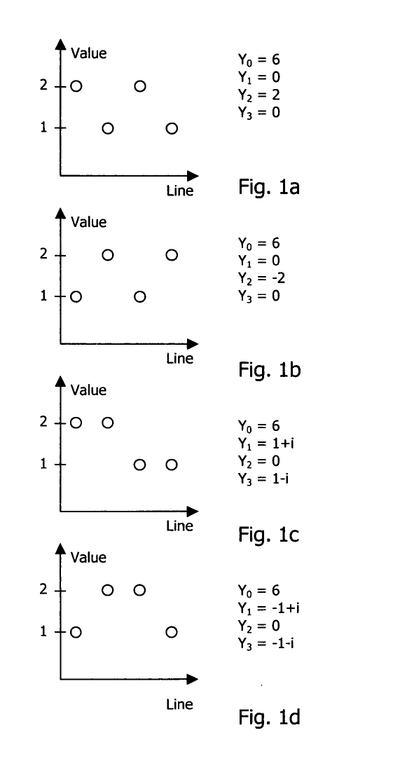

FIGS. 1a to d show diagrammatic diagrams for illustrating the theoretical principles and practical realization of the preferred embodiment of the present invention;

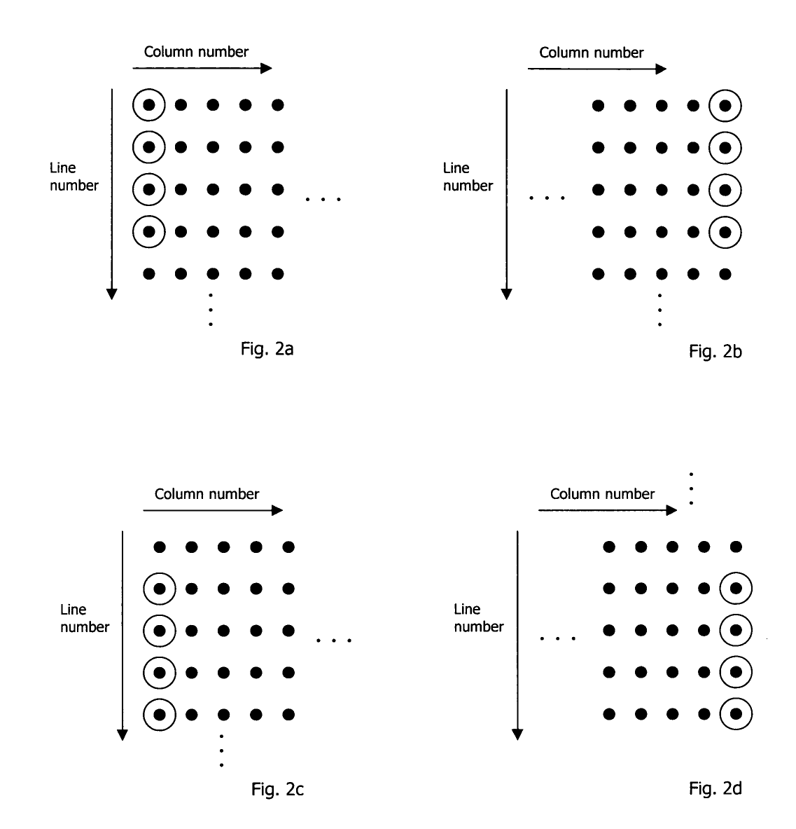

FIGS. 2a to d show diagrammatic representations for illustrating the scanning of an image in accordance with the present invention;

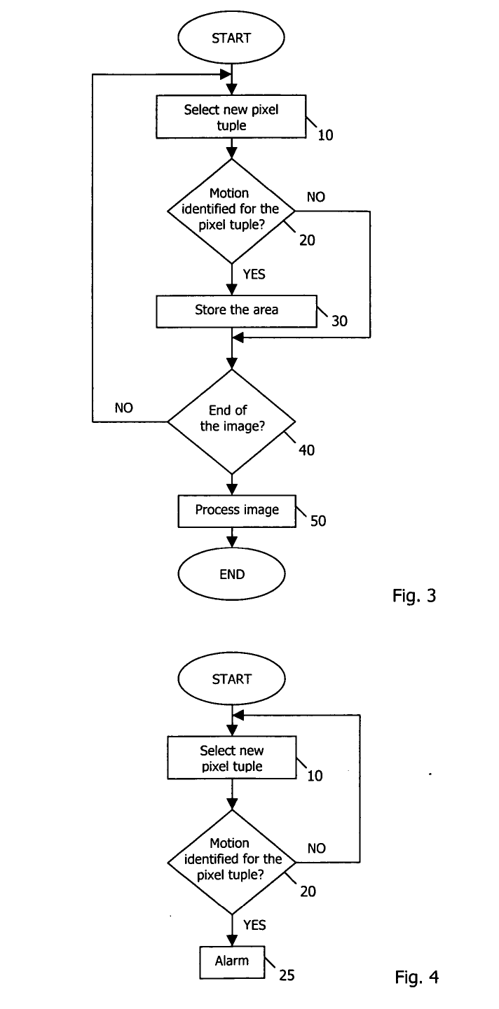

FIG. 3 shows a diagrammatic flow diagram for illustrating a first exemplary embodiment of the present invention for generating a still image;

FIG. 4 shows a diagrammatic flow diagram for illustrating a second exemplary embodiment of the present invention for producing a motion detector; and

FIG. 5 shows a diagram for illustrating the arising and the effects of the comb effect.

Diagrams for illustrating the present invention are represented diagrammatically in FIGS. 1a to d. The line number or the line index is represented on the x axis of the respective diagrams and a pixel parameter value is represented on the y axis. The pixel parameter value is a “coordinate” of a pixel color space, and preferably the luma (Y) of the YC_{b}Cᵣ color space. Increasing values of the Y value of the representation therefore correspond to an increasing brightness of the pixels, the color information being suppressed. In order to elucidate the preferred exemplary embodiment of the present invention, four pixels xₘ, m=0, 1, 2, 3, from the same column that lie directly one above the other are plotted in each case in the diagrams of FIG. 1a to d. In this case, the xₘ, m=0, 1, 2, 3 designate the pixel parameters of the individual pixels (pixel vectors), i.e. for example the luma. From the possible configurations, only four significant basic patterns are represented, for simplification, in FIG. 1a to d. In principle, for a range of values of two values given four pixels, there are precisely 2⁴=16 different basic patterns. Of these, the two basic patterns in which all four pixel values are 1 or 2 are not relevant anyway since, as is clear from the introduction, a comb effect cannot be present. Likewise, the types of basic patterns in which three pixel values are 1 or 2 are not relevant since a comb effect is likewise not present. The number of latter situations is 8 basic patterns (one of the four pixel values in each case is different from the remaining three, in which case the state of the remaining three pixel values may be 1 or 2). Furthermore, a representation of the situations which correspond to FIGS. 1c and 1d and in which x₀=1, x₁=1, x₂=2 and x₃=2 and, respectively, x₀=2, x₁=1, x₂=1 and x₃=2 has been omitted. In this respect, only four of the sixteen patterns that are possible theoretically are represented. The diagrams represented in FIGS. 1a and 1b therefore in each case correspond to a case in which a comb effect occurs. In contrast, the diagrams represented in FIGS. 1c and 1d, as well as the configurations not represented in the figures, in each case represent a case in which a comb effect is not present, rather e.g. a contrast edge as is generated by a camera is present.

In accordance with the preferred exemplary embodiment of the present invention, in order to be able to identify the comb effect, a Fourier transformation is applied to the pixel values of the pixels xₘ, m=0, 1, 2, 3 of four lines lying one above the other. The selection of four pixels is preferred in this case since fewer than four pixels do not always permit the presence of motion to be inferred with sufficient reliability and more than four pixels do not adequately delimit the area which is to be examined for motion and therefore impair the meaningfulness of the identification of motion with increased computational complexity. The Fourier coefficients permit the formulation of a simple and always significant criterion for the occurrence of the comb effect. Therefore, four pixel values xₘ, m=0, 1, 2, 3, shall be given. These are converted into four Fourier coefficients Yₙ, n=0, 1, 2, 3, by
Yₙ=Σ_{m=0,3}xₘe^{-iωmn}, ω=2π/4 (Equation 1).
Using the abbreviations
X⁺₀₂=x₀+x₂X⁺₁₃=x₁+x₃
X⁻₀₂=x₀−x₂X⁻₁₃=x₁−x₃
this yields for the Fourier coefficients Yₙ
Y₀=X⁺₀₂+X⁺₁₃ (Equation 2)
Y₁=X⁻₀₂+iX⁻₁₃ (Equation 3)
Y₂=X⁺₀₂−X⁺₁₃ (Equation 4)
Y₃=X⁻₀₂−iX⁻₁₃ (Equation 5)

The Fourier coefficients Yₙ, n=0, 1, 2, 3, which result in the cases of FIG. 1a to 1d, are in each case indicated to the right of the associated diagram. For the purpose of practical realization of the present invention, it is necessary, of course, only to calculate the Fourier transformation Y₁ and Y₂. The zigzag pattern of the comb effect ensures that the coefficients Y₁ and Y₃ can be disregarded with respect to Y₂, while they predominate with respect to Y₂ in the other cases, in which there is no comb effect present. Therefore, the criterion for the presence of motion is simply |Y₂|: |Y₁|≧S where S is a predetermined threshold value. This condition is the sole criterion to be checked in order to determine motion in the area of the image which comprises the four pixels. In this case, the quantity expressed in the absolute value may also be a complex number. In particular, this criterion is fulfilled if |Y₁|=0 holds true. In the drawing, the values of the pixel parameter, which is preferably the luma, are indicated by way of example as 1 and 2. However, this only serves for the purpose of illustrating the present invention and the criterion |Y₂|: |Y₁|≧S can be applied, in principle, to any situation that occurs in practice with all values for the pixel parameters, to be precise in particular on account of the selectability of the threshold or limiting value S, which is preferably approximately 8. Instead of the above criterion, it is also possible to use other criteria in particular without the aid of complicated computational operations, such as a Fourier transformation, e.g. by simply identifying jumps within predetermined ranges of values.

FIG. 2a to d diagrammatically represent how the group of four pixels from the image is successively selected, the method for motion detection described above in connection with FIG. 1a to d being carried out in each case. FIG. 2a to d in each case represent an area of the image of five by five pixels. FIGS. 2a and 2c in each case represent the top left area and FIG. 2b represents the top right area and FIG. 2d represents the bottom left area of the image as an excerpt. The pixel positions selected for processing are in each case represented by filled circles in FIG. 2a to d. Each pixel is unambiguously determined by its coordinates (line position or number, column position or number). In accordance with the ITU-R BT.601 video standard (formerly CCIR 601), the range of values for the line number is 1 to 720 and the range of values for the column number is 1 to 485. Therefore, on the basis of the line interlacing method explained in the introduction, the odd-numbered line numbers designate lines from the first field, while the even-numbered line numbers designate lines from the second field. The start of the scanning scheme according to the invention is represented in FIG. 2a. The four pixels of the first column having the lowest line numbers are selected as the first pixel quadruple. These are the four pixels (1,1), (2,1), (3,1) and (4,1). These pixels are marked by a circle in FIG. 2a to d. If, according to the method described previously, motion has been identified during the evaluation of this tuple, the presence of a comb effect is ascertained for the pixel having the second lowest line number, i.e. the pixel (2,1). The method is subsequently carried out correspondingly for the adjacent column situated on the right, i.e. the next tuple, (1,2), (2,2), (3,2) and (4,2). If, according to the method described previously, motion has been identified during the evaluation of this tuple, the presence of a comb effect is ascertained for the pixel (2,2). The method then advances further toward the right, up to the situation represented in FIG. 2b. For the ITU-R BT.601 video recommendation, these are the four pixels (1,485), (2,485), (3,485) and (4,485). If, according to the method described previously, motion has been identified during the evaluation of this tuple, the presence of a comb effect is ascertained for the pixel (2,485). The method is thereupon repeated in a manner displaced one line downward. This situation, i.e. the 486th repetition of the method, is represented with regard to the pixels (2,1), (3,1), (4,1) and (5,1) in FIG. 2c. The method is then carried out further in accordance with the above formation rule, FIG. 2d representing the last pixel tuple (720,485), (720,485), (720, 485) and (720, 485) of the video frame. For those pixels for which motion has been identified, editing or postprocessing is carried out after a complete scanning of an image. As has been described previously, this may be effected simply by omitting the corresponding pixel. An interpolation by pixels of the surroundings may equally be effected.

The sequence of the method according to the invention is described below with reference to FIG. 3. In a step 10, a new tuple of pixels, preferably a quadruple comprising four pixels, is selected in each case. The preferred selection specification has been explained in more detail above with reference to FIG. 2a to d.

Afterward, in step 20, an evaluation with regard to the occurrence of a comb effect is carried out. The preferred type of evaluation has likewise already been explained above in conjunction with FIG. 1a to d. If the result of this interrogation is YES, the areas or pixels in the case of which intra-frame motion has been identified are stored in a step 30. If the result of the interrogation in step 20 is NO, the method continues with step 40. In step 40, an interrogation is then made as to whether the entire video frame or the entire partial area of the image that is to be examined has already been scanned. If the result of this interrogation is NO, the sequence returns to step 10. Otherwise, i.e. if the result of said interrogation is YES, an image processing is carried out in a step 50 for the identified areas or pixels for which motion has been identified, in order to increase the reproduction quality of the image, in particular for suppressing disturbing effects resulting from the comb effect.

The flow diagram of FIG. 4 represents a variant of the invention in which an alarm is triggered after the identification of a comb effect or of motion in the video frame. The method represented in FIG. 4 has in part method steps that are essentially similar to the method represented in FIG. 3. In this respect, reference is made to steps 10 and 20. However, a significant difference consists in the fact that, if the interrogation in step 20 reveals that motion is present, this triggers an alarm in step 25. It goes without saying that, in accordance with a variant of the invention that is not represented, an alarm may be triggered in step 25 also only when the area in which motion is identified is sufficiently large, i.e. in the case in which, in particular, a plurality of interrogations in step 20 indicate the presence of motion in the image.

The invention has been explained in more detail above on the basis of preferred embodiments thereof. It is obvious to a person skilled in the art, however, that various adaptations and modifications can be made without deviating from the concept underlying the invention.

1. A method for identifying moving areas of an image having pixels, which image has been generated according to the line interlacing method, the image having two fields, a first field having the even-numbered lines of the image and the second field having the odd-numbered lines of the image, the method comprising:
for at least three successive pixels of the same column, one of the pixels originating from one field and the other two pixels originating from the other field, performing an evaluation of the at least three pixels with regard to a pixel parameter; and
depending on the result of the evaluation, identifying motion in an area of the image which has at least one of the three pixels.

2. The method as claimed in claim 1, wherein the evaluation is a comparison, two jumps in the pixel parameter values of the successive pixels indicating that motion is present in the area, while one or no jump in the pixel parameter values indicates that there is no motion present in the area.

3. The method as claimed in claim 1 wherein the pixel parameter value is one or more parameters of a color space.

4. The method as claimed in claim 3, wherein the color space is the YCbCr color space.

5. The method as claimed in claim 4, that wherein the pixel parameter is the luma (Y).

6. The method as claimed in claims 1, wherein the image is a video frame.

7. The method as claimed in claims 1, wherein a Fourier transformation is applied to the pixel parameters of the at least three pixels, from which corresponding Fourier coefficients are obtained, motion being identified if at least one of the Fourier coefficients fulfills a predetermined criterion.

8. The method as claimed in claims 1, wherein four pixels (xₘ, m=0,1,2,3) are used.

9. The method as claimed in claim 8, wherein the Fourier coefficients are determined by the following formula
Yₙ=Σ_{m=0,3}xₘe^{-iωmn}, where ω=2π/4,

|Y₂|: |Y₁|≧S being used as a criterion for identifying motion, and S being a predetermined threshold value.

10. The method as claimed in claim 8, wherein |Y₂|: |Y₁|≧S is used as a criterion for identifying motion, where Y₁=X⁻₀₂+iX⁻₁₃ and Y₂=X⁺₀₂−X⁺₁₃ where X⁺₀₂=x₀+x₂, X⁺₁₃=x₁+x₃, X⁻₀₂=₀−x₂ and X⁻₁₃=x₁−x₃ hold true, and S being a predetermined threshold value.

11. The method as claimed in claim 9 wherein the magnitude

|Y₂|: |Y₁|

represents a measure of the degree of motion.

12. The method as claimed in claim 11, wherein a plurality of threshold values are predetermined, the degree of motion being determined depending on the highest threshold value for which the assessment magnitude |Y₂|: |Y₁| is greater than or equal to this threshold value.

13. The method as claimed in claims 9, wherein the threshold value S lies in a range of values from approximately 5 to approximately 15.

14. The method as claimed in claims 1, wherein at least part of the image is scanned columnwise, from left to right, with, in each case, a group of at least three pixels of the same column that lie one above the other, in which case, after passing through essentially all the columns, the scanning is repeated in a manner displaced by essentially one line.

15. The method as claimed in claim 14, wherein the area of the image in which motion is identified is an individual pixel.

16. The method as claimed in claim 15, wherein the individual pixel is one of the inner pixels with regard to the group of pixels.

17. The method as claimed in claims 8, wherein the individual pixel is the pixel having the second lowest line number.

18. The method as claimed in claims 1, wherein an alarm is triggered in response to the identification of motion in the image.

19. A method for processing an image in which motion has been identified in accordance with a method of claims 1, wherein the image is accepted unchanged in areas in which there is no motion present, while only pixel information from one field is used for representing areas of the image in which motion has been identified.

20. The method as claimed in claims 15, wherein, for a location of the image in which motion has been identified, only the pixel value from one field is used for the representation, in which case, at respective locations of the other field at which motion has likewise been identified and which are adjacent to the location, use is made of substitute values obtained by an interpolation of pixel values of said one field from surroundings of the location.

21. The method as claimed in claim 20, wherein the surroundings of the location reach approximately as far as the third successive pixel of said one field.

22. The method as claimed in claim 1, wherein the method is implemented as a software program.

23. (Canceled)

24. A device for identifying moving areas of an image having pixels, which image has been generated according to the line interlacing method, the image having two fields, a first field having the even-numbered lines of the image and the second field having the odd-numbered lines of the image, wherein the device has evaluation means in order, for at least three successive pixels of the same column, one of the pixels originating from one field and the other two pixels originating from the other field, to carry out an evaluation of the at least three pixels with regard to a pixel parameter, in which case, depending on the result of the evaluation, motion is identified in an area of the image which has at least one of the three pixels.

25. The device as claimed in claim 24, wherein the evaluation means are comparison means, two jumps in the pixel parameter values of the successive pixels indicating that motion is present in the area, while one or no jump in the pixel parameter values indicates that there is no motion present in the area.

26. The device as claimed in claim 24, wherein the pixel parameter value is one or more parameters of a color space.

27. The device as claimed in claim 26, wherein the color space is the YCbCr color space.

28. The device as claimed in claim 27, wherein the pixel parameter is the luma (Y).

29. The device as claimed in claims 24 wherein the image is a video frame.

30. The device as claimed in claims 24, wherein a Fourier transformation is applied to the pixel parameters of the at least three pixels, from which corresponding Fourier coefficients are obtained, motion being identified if at least one of the Fourier coefficients fulfills a predetermined criterion.

31. The device as claimed in claims 24, wherein four pixels (xₘ, m=0,1,2,3) are used.

32. The device as claimed in claim 31, wherein the Fourier coefficients are determined by the following formula
Yₙ=Σ_{m=0,3}xₘe^{-iωmn}, where ω=2π/4,

|Y₂|: |Y₁|≧S being used as a criterion for identifying motion, and S being a predetermined threshold value.

33. The device as claimed in claim 31, wherein |Y₂|: |Y₁≧S is used as a criterion for identifying motion, where Y₁=X⁻₀₂+iX⁻₁₃ and Y₂=X⁺₀₂−X⁺₁₃ where X⁺₀₂=x₀+x₂, X⁺₁₃=x₁+x₃, X⁻₀₂=x₀−x₂ and X⁻₁₃=x₁−x₃ hold true, and S being a predetermined threshold value.

34. The device as claimed in claim 32 in that wherein the magnitude

|Y₂|: |Y₁|

represents a measure of the degree of motion.

35. The device as claimed in claim 34, wherein a plurality of threshold values are predetermined, the degree of motion being determined depending on the highest threshold value for which the assessment magnitude |Y₂|: |Y₁| is greater than or equal to this threshold value.

36. The device as claimed in claims 32, wherein the threshold value S lies in a range of values from approximately 5 to approximately 15.

37. The device as claimed in claims 24 wherein at least part of the image is scanned columnwise, from left to right, with, in each case, a group of at least three pixels of the same column that lie one above the other, in which case, after passing through essentially all the columns, the scanning is repeated in a manner displaced by essentially one line.

38. The device as claimed in claim 37, wherein the area of the image in which motion is identified is an individual pixel.

39. The device as claimed in claim 38, wherein the individual pixel is one of the inner pixels with regard to the group of pixels.

40. The device as claimed in claims 31, wherein the individual pixel is the pixel having the second lowest line number.

41. The device as claimed in any of claims 21, wherein the device has an alarm device, the alarm device being actuated and an alarm being triggered in response to the identification of motion in the image.

42. The device as claimed in claims 24, wherein the device furthermore has a device for processing the image, which accepts the image unchanged in areas in which no motion has been identified, while it performs a processing in areas of the image in which motion has been identified, only pixel information from one field being used.

43. The device as claimed in claims 38, wherein for a location of the image in which motion has been identified, only the pixel value from one field is used for the representation, in which case, at respective locations of the other field at which motion has likewise been identified and which are adjacent to the location, use is made of substitute values obtained by an interpolation of pixel values of said one field from surroundings of the location.

44. The device as claimed in claim 43, wherein the surroundings of the location reach approximately as far as the third successive pixel of said one field.

45. The device as claimed in claims 24, wherein the device is a microchip, a camera, a camcorder, a television set, a video recorder, or a DVD player.
